(19) United States
(12) Patent Application Publication
(10) Pub. No.: US 2024/0090516 A1
(43) Pub. Date: Mar. 21, 2024

(54) system and method to measure, identify, process and reduce food defects during manual or automated processing

(71) Applicant: Orchard Holding, SOUTH BEND, IN (US)

(72) Inventors: Rian Mc Donnell, CHICAGO, IL (US); Elise Weimholt, CHICAGO, IL (US); Aaron Brown, Sterling Heights, MI (US); Nicholas Lamb, PENN LAIRD, VA (US); Peyton Nash, Minneapolis, MN (US); Terrance Whitehurst, Colorado Springs, CO (US)

(73) Assignee: Orchard Holding, SOUTH BEND, IN (US)

(21) Appl. No.: 18/369,643

(22) Filed: Sep. 18, 2023

Related U.S. Application Data
(60) Provisional application No. 63/408,355, filed on Sep. 20, 2022.

(51) Int. Cl. A22C 17/00; G06T 7/50

(52) U.S. Cl. CPC A22C 17/008; A22C 17/0086; G06T 7/50; G06T 2207/20081; G06T 2207/30128

(57) ABSTRACT

The system and method to measure, identify, and reduce food defects from manual or automated processes uses a combination of sensors, computer vision, and machine learning to optimize yield, and quality for food processes. Specific features are monitored, analyzed, and quantified. Real time and aggregated data are available to relevant stakeholders to aid in understanding and optimizing food yield, quality and throughput. A cut guidance protocol, fingerprinting and embedding of food object is done using food data from a database in a processor.

### CROSS REFERENCE TO RELATED APPLICATION

This application claims priority to U.S. Provisional application 63/408,355 filed on Sep. 20, 2022. The contents of the said application is incorporated in its entirety herein by reference.

### FIELD OF STUDY

This disclosure details the system and method to measure, identify and process food and thereby reduce food defects during manual or automated processing of food.

### BACKGROUND

Food processing is about speed and as a result the quantity and quality can suffer. That leads to financial loss and a decrease in product quality. Manual processing is cumbersome and is dictated by individual judgments. The world needs a uniform technology to optimize the process, improving quality and yield both in manual and automated process.

### SUMMARY

This disclosure elaborates on the system, and method of measuring food processing, food yield, and food wastage. In one embodiment, a system is enables a butcher and a supervisor to perform a primal cut function on the meat according to customer requirement. In another embodiment, a software enables the machine to receive input based on customer requirement. The process and system operates automatically or can be controlled by operator or semiautomatic controlled by equipment's and system for processing the primal cut or any other meat processing steps.

The instant system and method is used during the processing of food in an industrial setting or individual processing instance. In one embodiment, the device in question can be additive to existing infrastructure (table, conveyor, etc.) or can be a new installation. In one embodiment, the device gathers food data from a food object continuously or at discreet moments specified by human input, algorithm and/or time.

In one embodiment a system contains an array of sensor to gather food data, processor to collect, analyze and give input to user and machines, guidance system to receive input from processor and produce guided process used by human or machine to process food object.

### BRIEF DESCRIPTION OF DRAWINGS

Example embodiments are illustrated by way of example only and not limitation, with reference to the figures of the accompanying drawings, in which like references indicate similar elements and in which:

FIG. 1 shows a high level method flow for the instant invention in one aspect.

FIG. 2 shows a typical processing station where a human processes a food object.

FIG. 3 shows the start of the process of trimming using the processing station as shown in FIG. 2.

FIG. 4 shows post scan the butcher gets the trim exact customer specification (tail), backstrap etc.

FIG. 5 shows once the meat is trimmed by the butcher and the lean meat is ready then the sensors capture the processed food object data.

FIG. 6 shows performance metrics and production results of a specific butcher.

FIG. 7 shows fingerprinted food object with a unique identifier to be stored in a database.

FIG. 8A, FIG. 8B, FIG. 8C and FIG. 8D shows individual feature performance for every food object as processed data.

FIG. 9 shows a flow chart instant invention work flow in one embodiment.

FIG. 10 shows a process flow for the software at the processor level.

FIG. 11 shows segmentation feature flow for the process.

FIG. 12 below shows a similar process as FIG. 11, with some additional steps.

FIG. 13 shows cut guidance feature of the process.

FIG. 14 shows another cut guidance feature flow in one embodiment.

FIG. 15 shows cut guidance feature flow with input from production plan.

FIG. 16 shows process of fingerprinting the food object with no transformations.

FIG. 17 shows fingerprinting of food object with transformation.

Other features of the present disclosure will be apparent from the accompanying drawings and from the detailed description of embodiments that follows.

### DETAILED DESCRIPTION

In this disclosure a system and method to measure, identify, process and reduce food defects during manual or automated processing is described. The instant system and method is used during the processing of food in an industrial setting or individual processing instance. In one embodiment, the device in question can be additive to existing infrastructure (table, conveyor, etc.) or can be a new installation.

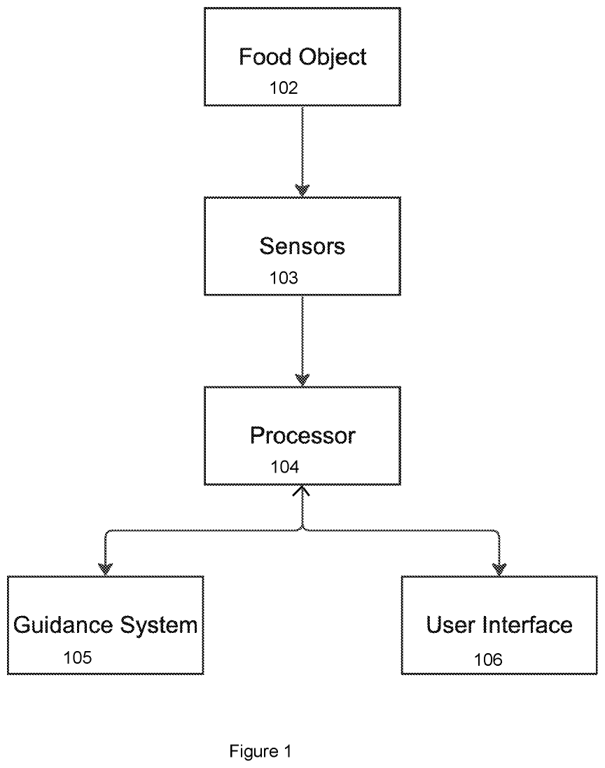

FIG. 1 shows a high level method flow for the instant invention in one aspect. The device gathers food data from a food object (102) continuously or at discreet times specified by human input, algorithm and/or time. Device is the physical hardware. A food object is a term used for a food that will be processed in some manner during the food processing operations. A primary food object is typically the largest or most valuable food object, for example the primal cut. Other food objects are typically lower value or smaller than the primary food object. Food data is the information or data gathered or captured from the food object by the device. The food data can be gathered continuously or discreetly. Discreet times when food object data are captured could be based on human input, timing, algorithm, or other external factors that signal to the device to capture food data. The device can also gather other data also referred to as non-food data continuously or at discreet times specified by human input, algorithm and/or time. Non-food data is any data gathered by the device that is not from the food object. Examples of this data include worker safety data, productivity data, foreign body data, equipment data, and hygiene data.

Worker safety data is information or data associated with human health and safety, such as information that personal protective equipment (PPE) is being worn, being worn correctly, potentially dangerous equipment is being used correctly, and other safety features are being monitored such as no-go areas around dangerous equipment, trip/slip hazards, etc. Productivity data is information or data associated with production capacity, effectiveness, and efficiency. Productivity data could include human efficiency, downtime (time not being productive), comparisons, speed of tasks, etc. Foreign body data is information or data associated with objects that should not be present. Identifying foreign bodies for removal reduces contaminants in food processing. Common examples of foreign bodies are gloves, plastic pieces, paper (e.g. labels), metal pieces, hair, other biological contaminants, bone chips, etc. Equipment data is information or data associated with equipment being used in food processing. Equipment data could include usage, effectiveness, errors in use, maintenance monitoring, replacement monitoring, task frequency, etc. Hygiene data is information or data associated with sanitation, and food safety. Hygiene data could include hand washing monitoring, equipment cleanliness monitoring, PPE cleanliness, monitoring hygiene facilities when relevant, etc.

The device uses sensors (103) to collect data, primarily from a food object, to provide the user(s) with information associated with yield, quality, errors, defects, identity and/or waste. Yield is the measure of product efficiency when comparing mass input to output in a process, for example 100% yield means the output was equal to the input (there was no yield lost). In food processing applications, the food object regularly has waste or yield loss from transformations, or any process that changes the food object. These transformations could include trimming, cutting, slicing, dicing, pealing, deboning, freezing, packing, compressing, moving, or any other change to the food object. Quality of a food object can be measured by a number of parameters, metrics, or features. Many quality metrics during food processing are proxies for eating quality, as it is impractical to test every food object with eating tests. Within quality is also how close the food object aligns with the set of specifications associated with it. Therefore food quality can include taste, texture, color, shape, dimensions, consistency, specific feature dimensions and metrics associated with parts of the food object, the internal content and distribution of contents, etc.

Errors and defects can also be a quality metric, or can attribute to lost yield. Errors include processing mistakes associated with the transformations mentioned previously. Defects are typically natural, caused by genetic deviation or other causes that are not as a result of processing errors. This could include misshapen food objects, bruised food objects, etc. Food object identity can include the type and subtype of food object (e.g. striploin beef primal). It can also include tracing the food object to the source of the food object. Waste is the avoidable yield loss, caused by errors and defects. The system can also collect non-food data, for example foreign bodies, contaminants, productivity data, human personnel data, health and safety data, hygiene data, and/or equipment data. Human personnel data is data associated with human workers in the food processing facility. This can include specific productivity data, worker identification, etc. An array of sensors, or 1 sensor can be used to gather food object data and non-food data. Examples of sensors used are cameras, depth sensors, IR emitters and receivers, load cells, other hyper-spectral imaging devices, and hyper-spectral probes.

The data from these sensors is processed in a processor (104). This process uses software algorithms, computer vision, and machine learning to produce results. These results consist of food information such as dimensions, features, defects, yield, quality, errors, identity, position, orientation, waste or any combination of such. Results can also consist of non-food information such as worker safety data, worker productivity data, foreign body data, equipment data, hygiene data or any combination of such. The Processor sends resulting data to output system (user interface 106). Human Machine Interface (HMI) outputs communicate relevant results with human users, supervisors, managers, or other relevant stakeholders. Examples of HMI outputs are screens, light signals, audio messages, or any other way to communicate information to a human. Output systems are systems to handle the final data in defined manners. Output systems include human machine interface(s), user interface(s) (106), screens, light signals, notifications, emails, dashboard(s) etc. They can be part of the device, or the data can be communicated to other devices or systems so they can communicate the relevant data (e.g. smart phones, tablets, computers, screens). Various User Interfaces (106) can be created for users such as managers, supervisors, operators, etc. These User Interfaces can use the Data from one or many devices. Notifications and Communications can also be triggered based on the Data within the Database.

The guidance system (105) uses outputs from the processor to produce guided processes. This guide could be in the form of augmented reality displaying relevant results and next steps. For example in a beef trimming scenario this could be an overlaid trimming pattern on a food object to assist the human trimmer to trim accurately and precisely. This guide could be in a digital form such as an augmented reality headset, or a physical form such as a projection of light (e.g. lasers) onto the physical food object. A guided process (also known as a guide) is a calculated process to efficiently achieve the desired food object transformation. This guided process is calculated by the processor and/or guidance system. In an alternate setup, this guidance system could be producing instructions for a robotic or autonomous system. This robotic system would perform the relevant processes on the food object. For example, a robotic arm, or pair of robotic arms trimming a beef primal to a specific set of targets or specifications. The end result of the processed food object can be passed to a user interface (or many user interfaces, including human machine user interface and dashboards for 1 or many users). The results could also be sent to the guidance system. The guidance system produces guided processes. These could be for human assistance (e.g. augmented reality or guides) or could be for autonomous systems (e.g. robotic solutions such as robotic arms).

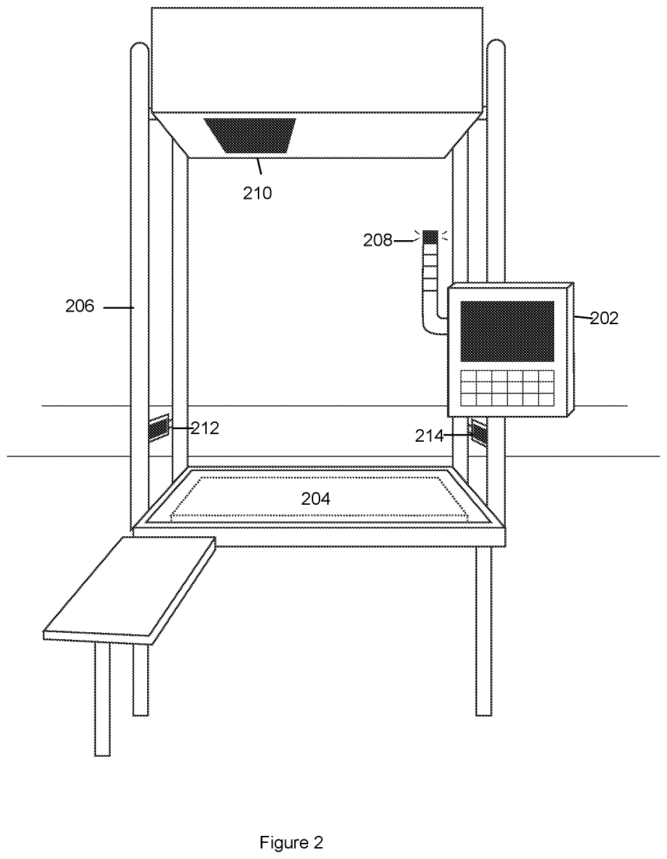

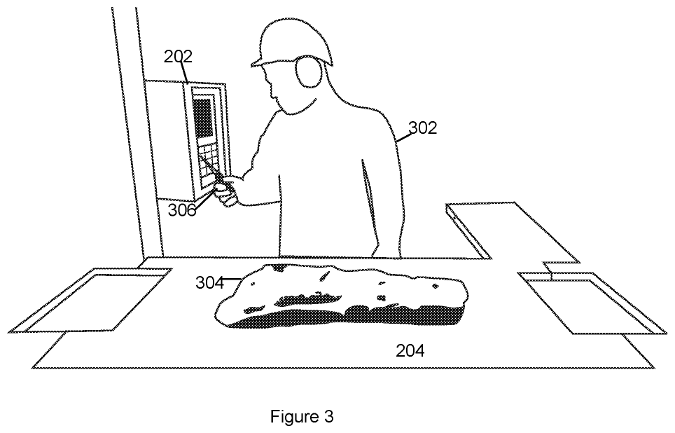

FIG. 2 shows a typical processing station where a human performs a processing task on a food object. Adaptive laser guide (210) capture the prescan image on the primal's untrimmed meat weight, dimensions, volumes and features. Sensors 212 and 214 deploys to help butcher to trim exact customer specification (tail), backstrap etc. After the food processing task is completed a light (208) is shown to indicate steps of the process, or the food processing task is complete. An interactive panel is used by the personnel to select and inform for data capture using an array of proximity sensors which activate when touched by a knife (202). A touchscreen or buttons could also be used as input sensors in other scenarios. The entire process is carried out on the tabletop (204). The tabletop could be augmented with a load cell for mass measurement. Additional processing area is shown as 206.

FIG. 3 shows the start of the process of trimming using the processing station as shown in FIG. 2. The operator (e.g. a butcher) (302) prompts (306) the input sensor (202) to activate the next step of the process. Typically, the food object (304) is scanned by the sensors (210, 212, 214) at the start of a process (for example but not limited to primal untrimmed meat) that is laid down on the tabletop (204). This same prompting (306) can be used for different at different times during the food processing, and can trigger the guidance system to show the relevant guide (402 and 404), and can trigger the sensors to capture data. In relevant scenarios, the operator (302) can select specifications, food object type, or other information with the input sensor (202).

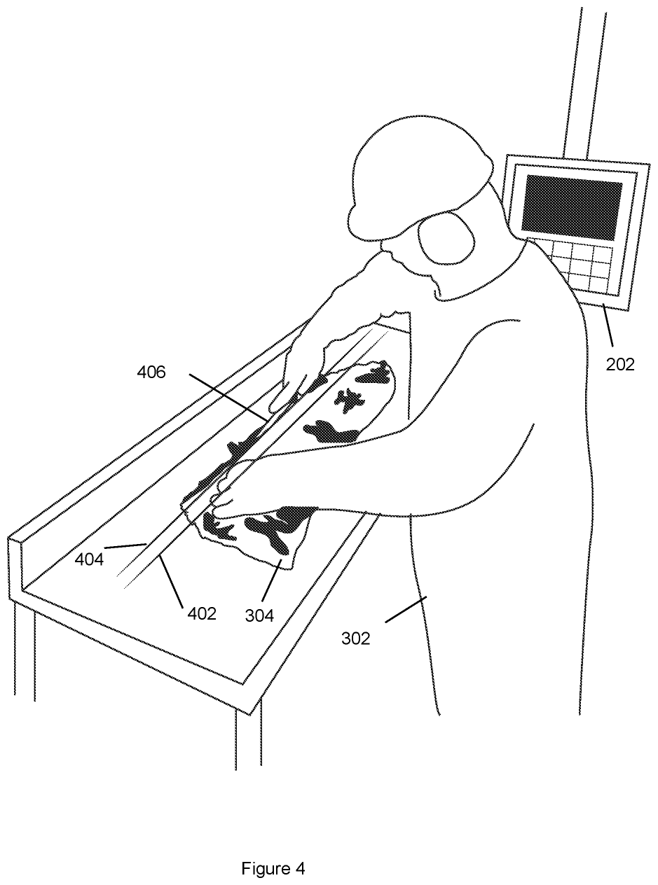

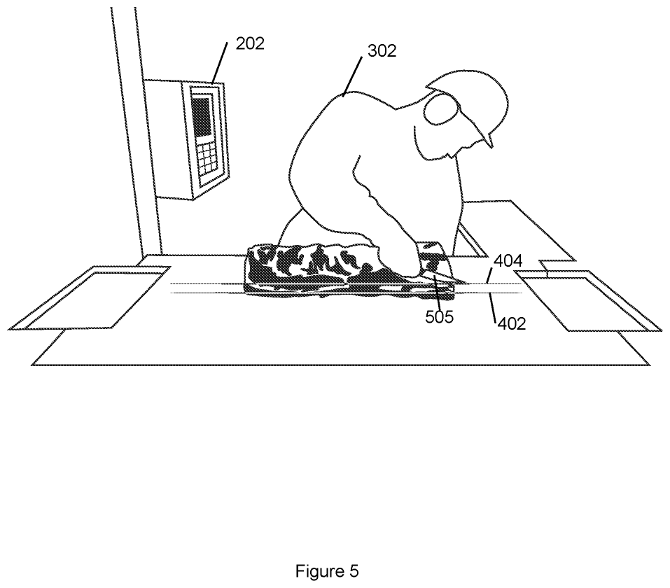

FIG. 4 shows post scan the butcher gets the trim exact customer specification (tail), backstrap etc. The process is guided by two light source or laser or any other guiding mechanism (402 and 404). The butcher then trims (406) the meat on the lean side and the fat side of the primal untrimmed meat to exact customer specification (tail), backstrap etc., by laser guidance for example. FIG. 5 shows once the meat is trimmed by the butcher and the lean meat is ready then the sensors capture the processed food object data. Once the operator performs food processing task at the processing station for a food object using the food data generated by the device using a specific software algorithm, a computer vision and machine learning algorithm residing in a processor to produce a processed data. One or many devices can send their data to a database for storage, analysis and presentation. The database stores all the relevant data, additional data such as specification data or production planning data can be stored in separate databases or the same database. This specification or production Plan data can then also be sent back to the Processor on the device when required. Specification data is data associated with the required specifications for defined food objects. Specifications can be set per customer, food object, food type, gender, species, breed, or any combination of these factors. Production planning data is the plan a food processor aims to achieve for a specified period of time (e.g. one batch, one shift or one day). This production plan is based off what customer orders need to be filled, the timing of specific orders, the specifics of the food objects to be processed (e.g. quality, anticipated yield, how aligned they are with customer orders, etc.), and could include other data such as labor availability. Report Generation can also be carried out manually or autonomously based on the data within the Database.

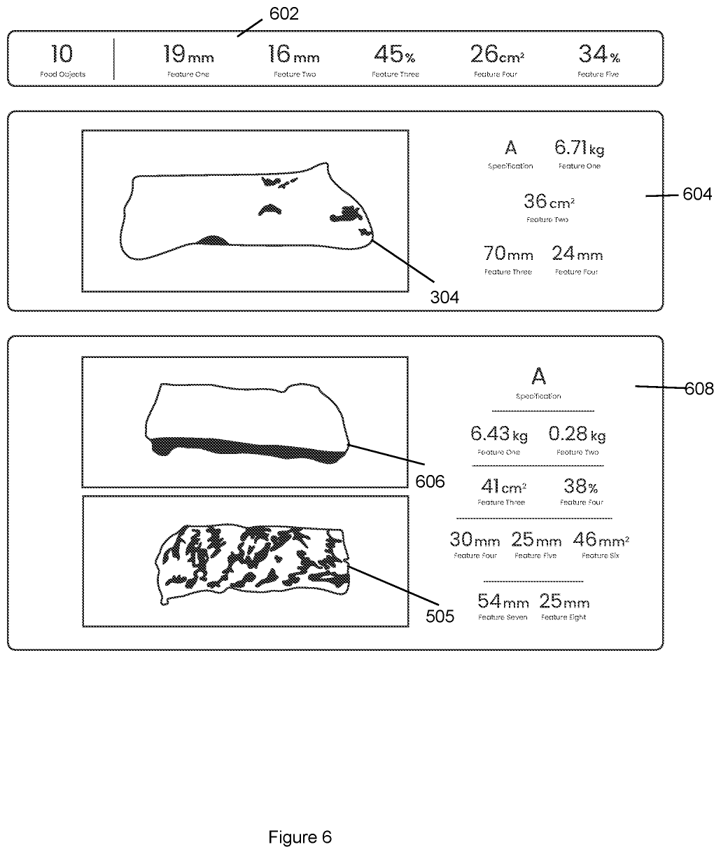

FIG. 6 shows performance metrics and production results of a specific butcher. The table 602 show for the butchers last 10 food objects they have processed. Untrimmed food object 304 and its specifics of weight, height, thickness and other features (604) is shown towards the side. This user interface may be used by several users for several functions. Partially trimmed food object 606 shows similar measurements after processing on panel 608 along with finished final food object 505.

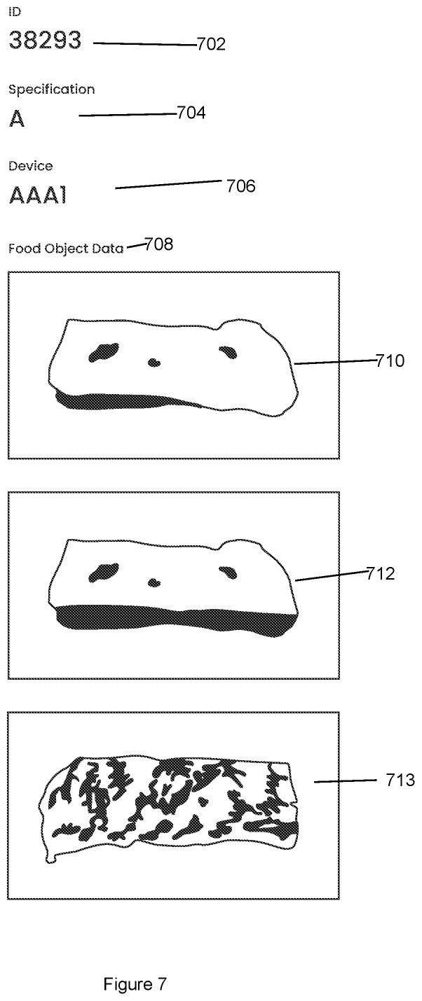

FIG. 7 shows fingerprinted food object with a unique identifier to be stored in a database. An identification number is created for each food object that processed (702) in a database. The associated specification data (704) is also linked along with what device was used for capturing the data (706). The pictorial representation of the food object data (708) that was processed in various stages (710, 712, 713) are also stored so visual inspection can be done at a later date.

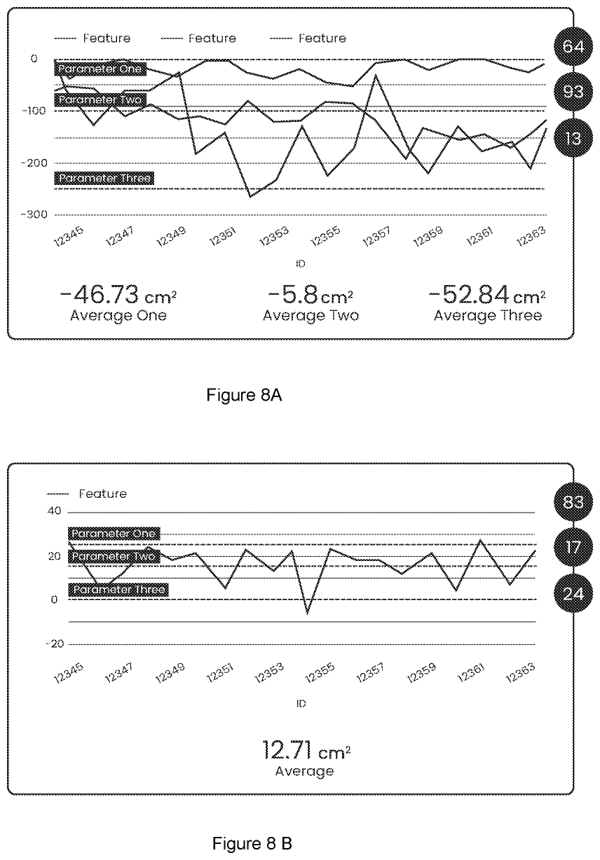

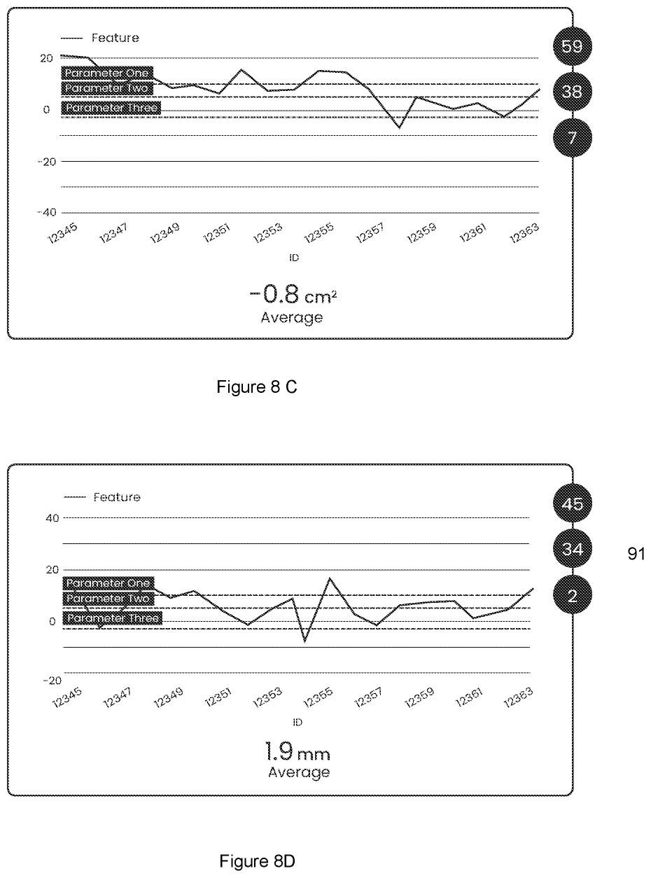

FIG. 8A, FIG. 8B, FIG. 8C and FIG. 8D shows individual feature performance for every food object as processed data. These figures can be filtered to include desired datasets of food objects (e.g. 1 shift, 1 operator, 1 day, last 100 food objects etc.). FIG. 8A shows a feature that is captured at multiple stages of food processing, with each line showing the value for a stage. An example feature would be fat coverage defects on beef primals. These could be introduced in a variety of food processes and therefore are measured at multiple stages to identify the cause of the defects. FIG. 8B shows a single feature for each food object. For FIGS. 8A, 8B, 8C and 8D parameter One, Two, and Three are set as references for the given feature defining what is a good result, a bad result and a very bad result? The number of good, bad and very bad results is also shown in a traffic light arrangement (green, yellow, red) on the right side of each graph for quick reference. FIGS. 8A, 8B, 8C, and 8D also have any key metrics displayed below the graph (e.g. average). FIGS. 8A, 8B, 8C, and 8D could use absolute values for the relevant features, or be relative to a given target. This target could be a specification or any other value.

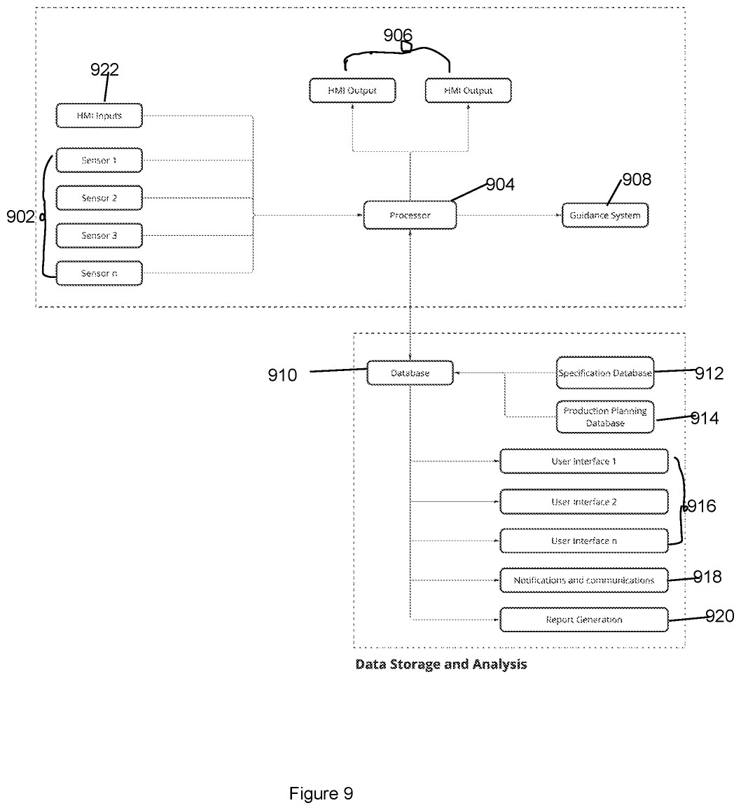

FIG. 9 shows a flow chart instant invention work flow in one embodiment. The device in question can be additive to existing infrastructure (table, conveyor, etc.) or can be a new installation. The device gathers food data from a food object continuously or at discreet moments specified by human input, algorithm, other machine input, and/or time. The device can also gather other data continuously or at defined moments specified by human input, algorithm, other machine input, and/or time. Examples of this data include worker safety data, worker productivity data, foreign body data, equipment data, and hygiene data. The device uses sensors to collect data, primarily from a food object, to provide the user(s) with information associated with yield, quality, errors, defects, identity and/or waste. The system can also collect non-food data, for example foreign bodies, contaminants, productivity data, human personnel data, health and safety data, hygiene data, and/or equipment data. An array of sensors (902), or 1 sensor can be used to gather food and non-food data. Examples of sensors used are cameras, depth sensors, IR emitters and receivers, load cells, other hyper-spectral imaging devices, and hyper-spectral probes. The data from these sensors is processed in a processor (904). This process uses software algorithms, computer vision, and machine learning to produce results. These results consist of food information such as dimensions, features, defects, yield, quality, errors, identity, position, orientation, waste or any combination of such. Results can also consist of non-food information such as worker safety data, worker productivity data, foreign body data, equipment data, hygiene data or any combination of such. The Processor sends resulting data to Output devices. Human Machine Interface (HMI) Output (906) communicate relevant results with human users, supervisors, managers, or other relevant stakeholders. Examples of HMI outputs are screens, light signals, audio messages, or any other way to communicate information to a human.

The guidance system (908) uses outputs from the Processor to produce guided processes. This guide could be in the form of augmented reality displaying relevant results and next steps. For example in a beef trimming scenario this could be an overlaid trimming pattern on a food object to assist the human trimmer to trim accurately and precisely. This guide could be in a digital form such as an augmented reality headset, or a physical form such as a projection of light (e.g. lasers) onto the physical food object. In an alternate setup, this guidance system could be producing instructions for a robotic or autonomous system. This robotic system would perform the relevant processes on the food object. For example, a robotic arm, or pair of robotic arms trimming a beef primal to a specific set of targets or specifications.

One or many devices can send their data to a database (910) for storage, analysis and presentation. The database stores all the relevant data. Additional data such as specification data (specification database (912) or Production Planning Data (production planning database (914) can be stored in separate databases or the same database. This Specification or Production Plan data can then also be sent back to the Processor on the device when required. Various User Interfaces (916) can be created for users such as managers, supervisors, operators, etc. These User Interfaces can use the data from one or many devices. Notifications and communications (918) can also be triggered based on the data within the database. Report Generation (920) can also be carried out manually or autonomously based on the data within the database. Generating a final data after analysis of the processed data by the system for a user is performed.

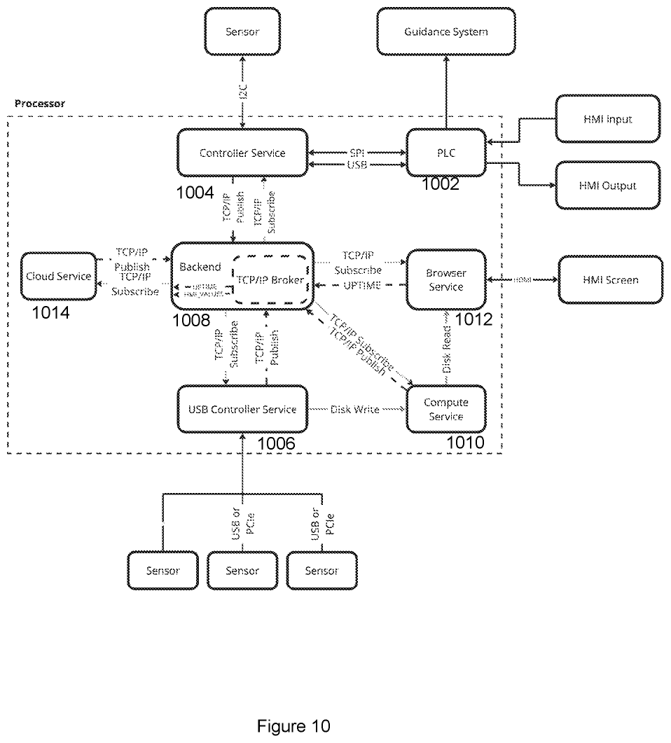

FIG. 10 shows a process flow for the software at the processor level. The processor is broken down into a variety of services. A service is software that performs automated tasks, responds to hardware events, or listens for data requests from other software. Hardware events could include human input via button press, sensor activation, or other communication method such as voice activation, other sensor activation or specific data input (e.g. load cell data), or feedback loops associated with hardware devices such as moving mechanisms, end effectors, robotics, actuators, etc. FIG. 10 shows a setup of the Processor as well. There are many substantially similar setups that can be derived with non-novel changes to this setup. Specific communication protocols are listed, however alternative protocols could also be implemented in many scenarios. Non-novel changes could include combining services, extracting functionality into separate services, or similar actions, that result in the same system but in a different configuration. Communication protocols allow computers and/or machines to efficiently send information in a reliable manner that is standardized and understandable. Communication protocols allow for system creators to adopt existing standards, and not have to define their own standard for communication. The Controller Service (1004) interfaces with the Programmable Logic Controller (PLC) (1002), or similar real time controller system. Serial Peripheral Interface (SPI) can be used to communicate data such as HMI Inputs (922) (e.g. button presses or sensor inputs), Guidance System input data (e.g. cutting patterns or laser guide positions) or HMI Output data (e.g. LED status states). USB (Universal Serial Bus) is also used to reprogram the PLC. The Controller Service publishes data such as HMI Input received from the PLC, System Reliability metrics, or triggers associated with data capture. The Controller Service (1004) can also subscribe to receive data such as acknowledgment of successful data capture. This publishing and subscribing communication system is standard in software communications, typically using Transmission Control Protocol/Internet Protocol (TCP/IP) or protocols built upon TCP/IP such as MQTT (originally an initialism for Message Queuing Telemetry Transport, but now just a name for the protocol which does not queue messages). Publishing is “sending” data from a service, while Subscribing is setting a desire to receive data from that topic (an example of a topic could be the data from a sensor, or an input from the HMI). The Controller Service can also interface with relevant sensors that do not require high band width (USB or PCIe), for example a load cell. I2C (Inter-Integrated Circuit) or similar communication protocols can be used to communicate with sensors.

The PLC or similar real time controller system interacts with relevant hardware systems that require accurate real time control. HMI inputs and outputs that are not graphically based (e.g. screen) are controlled by the PLC. These could be controlled by other Processor services, but the PLC is optimum for reliably and robustly performing these tasks. The PLC also typically sends the relevant data to the guidance system. The guidance system could receive this information from other services depending on the exact implementation, but when physical hardware guidance such as moving lasers, projection, or robotics are involved, the PLC is most suited to command these systems.

The Backend Service (1008) runs the TCP/IP Broker which is a piece of software that acts like a post office for the software service communications. All Published data is sent to the Broker and it ensures that any service that has subscribed to a topic receives a copy of that data. The Backend Service also runs a server allowing for remote access. A framework such as Flask, or similar, can be used for this server. Remote access is the ability of users to access a device from a different location. The USB Controller Service (1006) interfaces with sensors connected with USB (Universal Serial Bus), PCIe (Peripheral Component Interconnect express), or a similar method to connect sensors to a software processor. Typically, these sensors are collecting a lot of data, and therefore require high bandwidth communication methods like USB or PCIe. Examples of sensors interfacing with the USB Controller are cameras, depth cameras, depth sensors, or hyperspectral sensors. The USB Controller Service communicates with TCP/IP. The USB Controller Service controls what data to save from the relevant sensors. If data is too large for a TCP/IP protocol to communicate between services conveniently and quickly, it can also be saved to memory that can be accessed by relevant services.

The Compute Service (1010) uses MQTT to trigger processes or methods. It can also read and write to memory for larger amounts of data (e.g. large image or depth files). The Compute Service uses algorithms and models to run relevant calculations on data, such as calculating food object features, dimensions, quality, defects, errors, identity, position, orientation, waste or any combination of such. The Compute Service can also calculate non-food information such as worker safety data, worker productivity data, foreign body data, equipment data, hygiene data or any combination of such. The Browser Service (1012) interfaces with the Human Machine Interface Screen if present, via HDMI or similar protocol. The Browser Service manages the user interface displayed on the screen, and the data associated. If the screen is a touchscreen, the Browser Service manages inputs. The Browser Service also uses TCP/IP to communicate to other services.

The Cloud Service (1014) is responsible for uploading all relevant data to the external database for storage, analysis or presentation. The cloud service also receives data. Examples of data being received by the Cloud Service include whenever Specification Data for food objects is changed, Production Plan data or confirmation that data has been successfully uploaded to the external database. The Cloud Service uses TCP/IP to communicate with other services, and also can avail of reading from memory for larger data (e.g. large images or depth files). It would be possible to create substantially similar processor flows by combining functionality from different services, making slight tweaks such as communication protocols, or moving functionality between services. All these alternatives would be considered substantially similar to the process flow laid out above.

Small alterations are regularly made to hardware depending on specific requirements. In this scenario, the device is powered by alternative current (AC). Protection circuitry is used to avoid device electrical damage (e.g. surge protection) in the event that abnormal electric current or voltage is detected. The AC power is distributed to the relevant Direct Current (DC) Power Supplies that convert the AC to DC Power at the desired voltage. Typically 5V or 12V DC power is used in Processors such as the one in this device. 24V DC power is used to power the PLC (Programmable Logic Controller) or similar controller. The PLC is part of the overall Processor system, however the PLC (1002) is running on different power and is physically different hardware in this scenario. The PLC and Processor have Remote Reset capabilities controlled by each other. This allows the PLC to reset the rest of the Processor, or the Processor to reset the PLC. This is helpful for software updates and resolving errors. This Remote Reset system consists of Relays that control the power being supplied to the relevant hardware. The Human Machine Interface (HMI) screen is typically on an individual power supply for convenience, although that does not need be the case. The HMI inputs can be powered from the relevant DC power, in this iteration 24V, and send their signals to the PLC.

In this scenario, 3 sensors are connected to the processor via USB 3.0 connections. These sensors are positioned relative to the food object in order to collect the relevant data. Examples of these sensors are cameras, or depth sensors. 1 Analog sensor is also used in this scenario. An example would be a load cell positioned to collect mass data of the food object. Depending on the output signal of the analog sensor, an amplifier may be required, along with an analog to digital converter (ADC) if the analog sensor is being connected to the Processor (excluding the PLC). The analog sensor could alternatively be plugged into the PLC without an ADC, depending on the specific scenario. The guidance system is typically connected to the PLC, depending on the method of guidance.

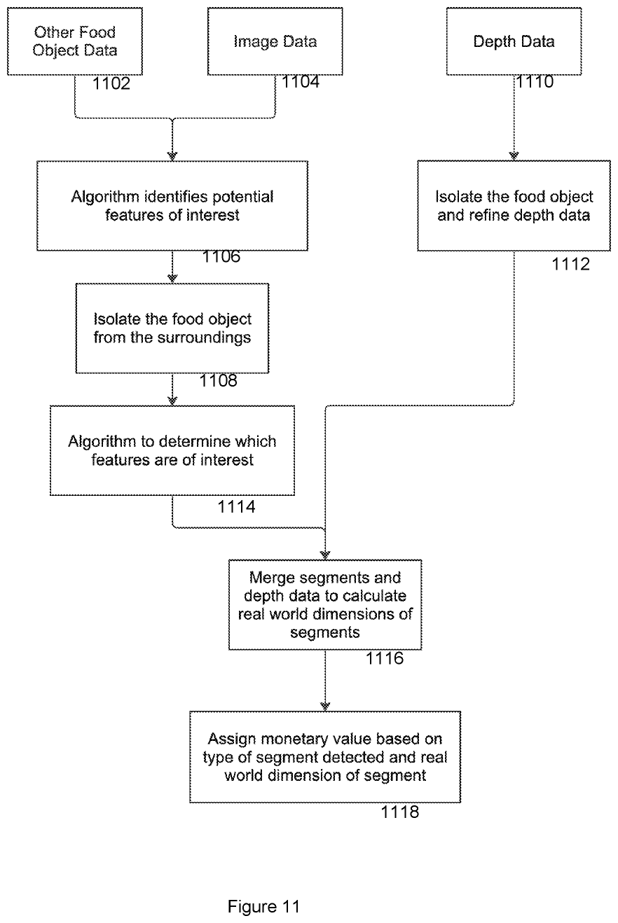

FIG. 11 shows segmentation feature flow for the process. Image Data (1104), Depth (3 dimensional point cloud) Data (1110) and other food object Data (1102) is collected for the food object using sensors, inputs or any combination of sensors and inputs (e.g. in some scenarios the user may select food object type, or other traits, for a batch of food objects or individual food object using a user interface, buttons, or other mechanisms to input data. Image data is information or data captured from a camera or similar device. Typically image data is a matrix of color data (for example red, green and blue) that can be represented in pictorial form. The Image Data is input into algorithms such as machine learning models or computer vision software which identifies potential features of interest (1106). Segmented areas for each relevant features are created. Food object data can be used to decide which algorithm is used or to alter the algorithm in question, before identifying the features of interest. An example of this in beef primal trimming operations would be the input “Primal Type”, which could be attained via user input or via software algorithm (machine learning model or computer vision software), deciding which machine learning model or software to use, as each model or software algorithm may be optimized for specific primal types.

The food object data is processed to isolate the relevant food object (1108) from the surroundings. Any unnecessary data is filtered out. This step can also happen before the previous process of identifying potential features in some process flows. An algorithm determines and identifies the relevant feature(s). These features are typically defects, errors, physical attributes associated with the food object, or production attributes (for example the size of an area that has been trimmed) (1114). Using metrics such as dimensions, positioning, and orientation, food object data, and confidence metrics for each feature a software algorithm determines which are of interest and which can be ignored. Confidence metrics are based on calculations of how confident or how likely an algorithm or machine learning model is correct that it has identified a relevant feature. Dimensions of a food object can be basic such as length, width, height, volume, or they could be dimensions associated with specific features of the food object such as tail length, stem length, bruise size, etc. Depth Data (1110) is processed to isolate the relevant food object (1112). Depth Data can then be merged (1116) with the Image Data and features of interest to calculate real world dimensions associated with the features. When relevant, a final algorithm takes these dimensioned features and calculated monetary value to them based on relevant data (1118). This monetary value is typically a gain or loss when compared to a target outcome for the food object and can consider aspects such as yield, quality, change in food object price point, probability of rejection, claim, or complaint, or any combination of these aspects.

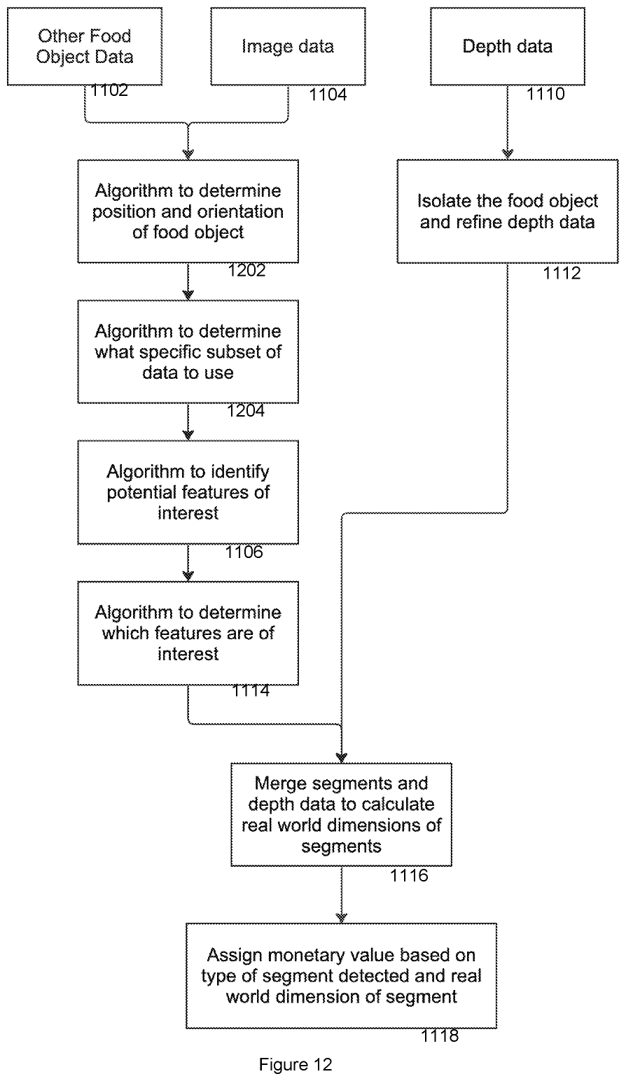

FIG. 12 below shows a similar process as FIG. 11, with some additional steps. Here an algorithm is used to determine the position and orientation of the food object (1202). This algorithm could be a machine learning model or other software algorithm. This step is required for some features as they may only occur in a specific area/volume of the food object. The position and orientation data is passed to another algorithm that determines what specific subset of data to use (1204). This subset could be data from specified sensors, data from a specified area/volume of the food object, or any other subset. At this stage, the food object could also be isolated from the surroundings and unnecessary data filtered out.

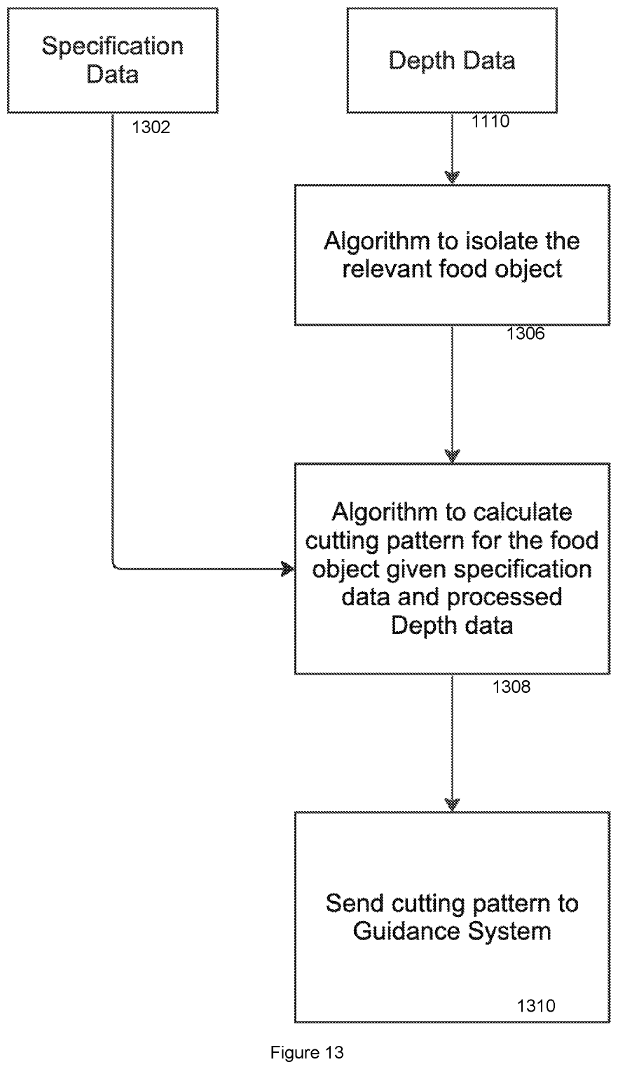

FIG. 13 shows cut guidance feature of the process. Food object data is collected using sensors. This food object Data is processed to isolate the relevant food object. Any unnecessary data is filtered out. This food object data is primarily Depth Data (3-dimensional) (1110) and Image Data. Specification Data (1302), which defines the targeted final food object features, proportions, quality, and margins of error is input, either by manual selection or by algorithmic calculation. Algorithm is used for isolating the food object (1306). The depth data and specification data can then be used to calculate the optimum cutting pattern. This algorithm varies depending on the type of Specification, the required cutting, and the type of food object (1308). One example is for beef primals that need to be trimmed at their tip to provide a minimum surface area, or dimension associated with the end face of the primal. If the minimum face depth is a specification that is set in specification data, the algorithm uses that information and performs depth calculations on the food object to calculate where to trim, in order to remove the volume of Food object that does not meet the specification. When the cutting pattern has been calculated, it is sent to the Guidance System (1310).

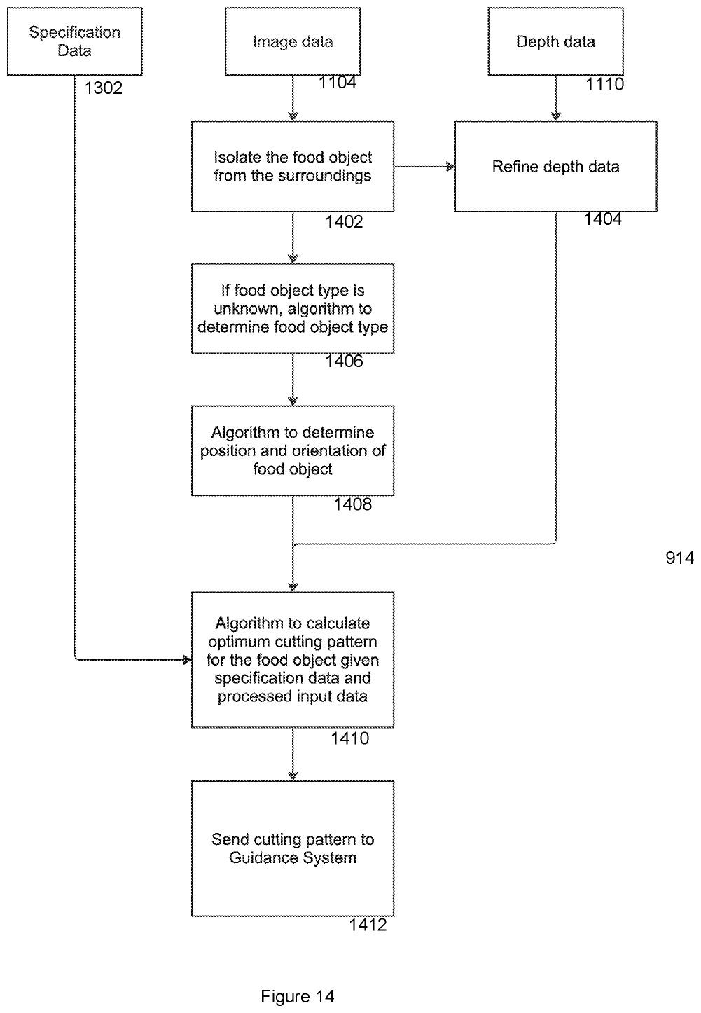

FIG. 14 shows another cut guidance feature flow in one embodiment. In this embodiment, a more complex flow is described to calculate the cutting pattern. Here Image data (1104) and Depth Data (1110) are both collected using sensors. The cutting pattern or trimming pattern, is a guide or guidance pattern for operations involving cutting or trimming. The cutting pattern could consist of straight lines, curves, projected angles, 3D geometries and shapes, etc. The food object data is processed to isolate the relevant food object from the surroundings. Any unnecessary data is filtered out of the Image data and Depth data. Isolating the relevant food object (1402) means filtering out data that is not associated with the food object data is being described. Another step could be to refine depth data (1404) to feed into cutting pattern algorithm. If the type of the food object is unknown, an algorithm is used to determine the type of food object (1406). This algorithm could be a machine learning model or another software algorithm. An algorithm is then used to determine the position and orientation of the food object (1408). This algorithm could be a machine learning model or another software algorithm. The processed input data, including the position, orientation, food object type, refined depth data, and image data can be used to calculate the optimum cutting pattern (1410) for the food object given the relevant specification data (1302). This cutting pattern is sent to the guidance system (1412).

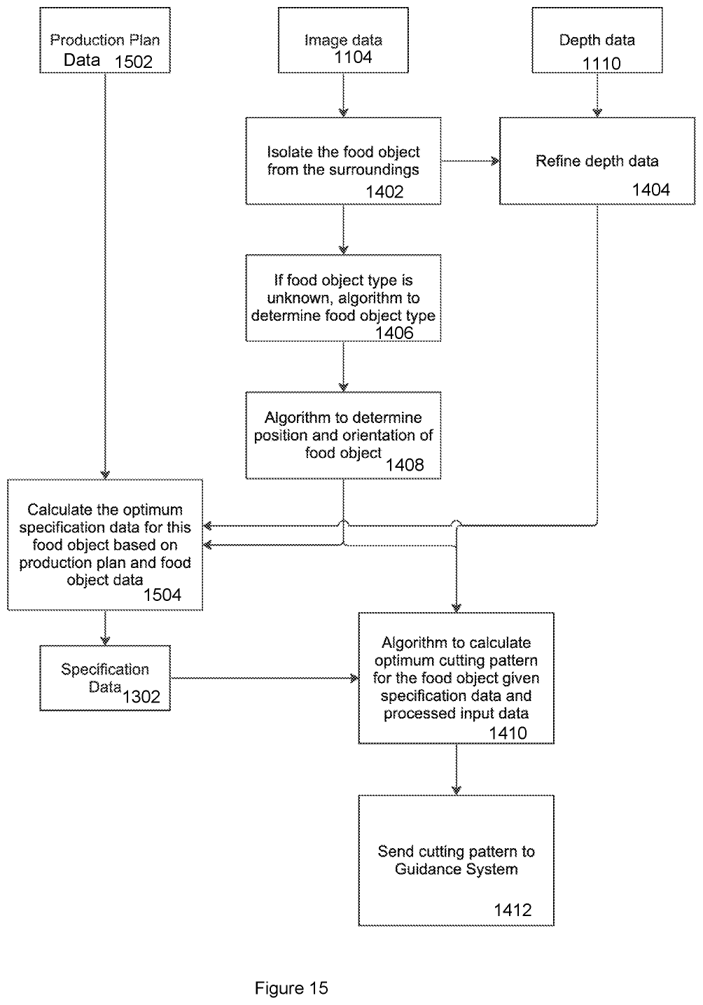

FIG. 15 shows cut guidance feature flow with input from production plan. In this embodiment, specification data is algorithmically calculated. To calculate the specification data (1302) algorithmically, production plan data (1502) must be known. Production plan data is the outline for what should be produced over a period of time, e.g. 1 shift or day. Production plan data is calculated based on sales or order quantities, delivery schedules, and the properties of incoming food objects. In the case of meat, these food properties include breed, age, size, quality, fat %, defects, etc. The food object data and production data are used to optimize which food objects should be trimmed with which specifications to complete the production plan (1504). This optimization calculation results in specification data for each food object, which can then be passed into the Algorithm to calculate cutting patterns, as shown in FIG. 14 before.

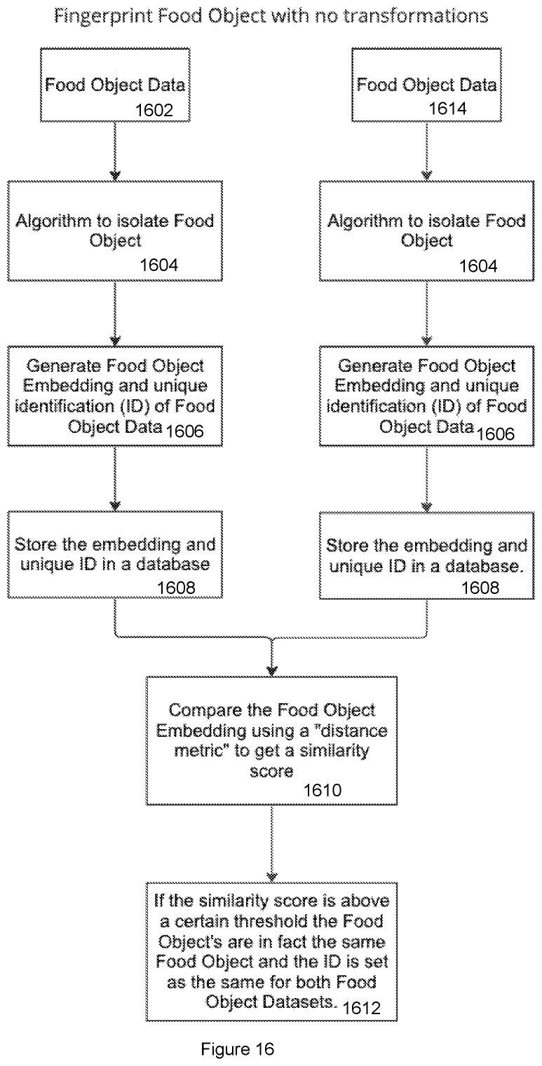

FIG. 16 shows process of fingerprinting the food object with no transformations. Fingerprinting is the process of identifying if a food object is the same as a previous food object. The primary purpose of fingerprinting is traceability and to know where a food object has been, what process has occurred, and therefore all the data and metrics associated with that food object can be tracked more accurately (e.g. individual object yield, quality, eating quality, yield and quality change through each production step, health and safety data). Food object data (1602) (1614) is collected from the relevant sensors (e.g. camera, depth sensor, load cells, hyper-spectral sensors, hyper-spectral probes, penetrative sensing technologies such as MRI or CT scan). The food object data is filtered or cleaned to isolate the relevant food object and remove unnecessary data (1604). An embedding of the food object is generated, along with a unique identification (ID) (1606). An Embedding is a series of vectors representing characteristic features of the food object. Embedding's are commonly used in in classification software, for example a type of flower such as a sunflower has a distinct look, which in turn creates a distinct embedding representing those features. When a software is trying to decide if an image contains a sunflower it can compare the generated embedding with the embeddings of known sunflower images. The embedding and Unique ID are stored in a database for each food object (1608). In order to determine if a food object is the same food object the embeddings are compared using a “distance metric” to get a similarity score (1610). The “distance metric” is a method to calculate the difference in the vectors associated with the embedding's, so a small distance would mean the food objects are more similar. If the similarity score is above a certain threshold it can be concluded that the food objects are in fact the same food object and the ID can be overwritten so both food object database entries have the same ID (1612). If the similarity score is below the threshold it can be concluded that the food objects are different and therefore both retain their unique ID. This process flow is primarily for fingerprinting food objects when no transformation, or minor transformations have occurred. Examples of transformations include trimming, cutting, slicing, dicing, pealing, deboning, freezing, packing, compressing, moving, or any other change to the food object.

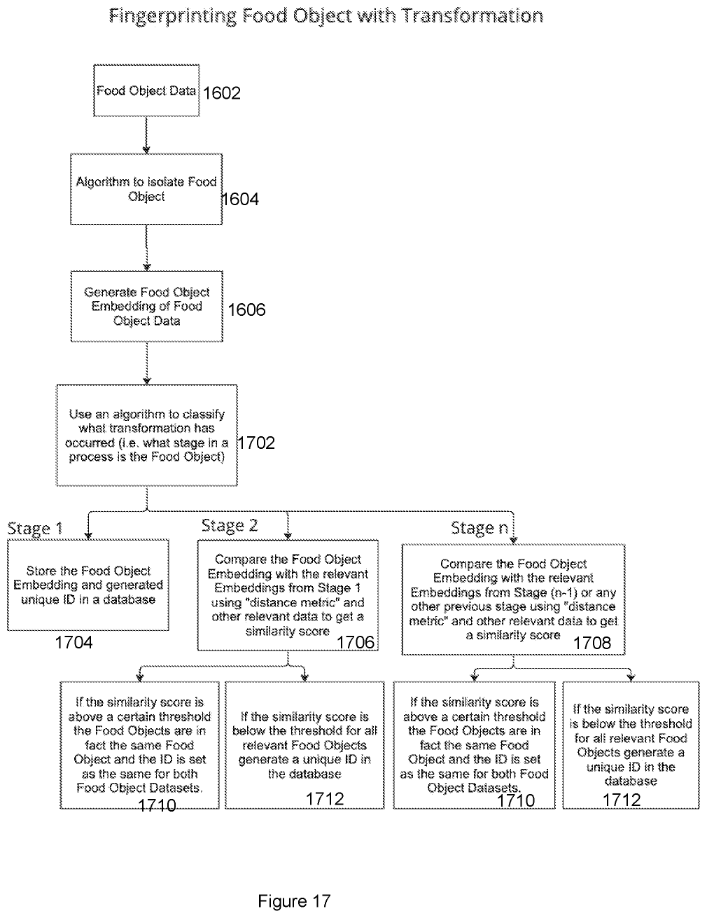

FIG. 17 shows fingerprinting of food object with transformation. The embodiment described below shows a generalized process for “n” stages, where n could be any natural number (1, 2, 3, etc.). The stages represent different relevant points in a food process. Between each point a food transformation may or may not have occurred, depending on the stages in question. Similar to FIG. 16 the food object data (1602) is processed to isolate the relevant food object (1604), and an embedding of food object is generated and assigned (1606). An algorithm is used to classify (1702) what transformation has occurred on the food object. This algorithm could use the context of what stage the food object is at in the process, or could use machine learning or other software algorithm to review the food object data to determine relevant transformations.

At Stage 1 (1704), there is no previous food object data to compare with, as this is the first time the food object data is being collected, so a unique ID is generated and the embedding is stored. At all other stages, the new food object embedding can be compared to a stored food object embedding. For example, at Stage 4, the new embedding could be compared to Stage 3, or Stage 2 (1706), or Stage n (1708), or any combination of those embeddings, depending on the scenario. If the similarity score is above a threshold (1710), the food objects are determined to be the same and their IDs are set to the same value in the database. If the similarity score is below the threshold for all relevant food object the algorithm generates a unique ID in the database (1712). In calculating this similarity score, other data can be used along with the embedding. For example, timing data can be used to filter out food objects, or as a probability weighting factor. If the normal time difference between two stages is known, or if the minimum and maximum time is known, these can be used to ignore some food objects, to avoid false positives. In food processing scenarios, timing is typically well defined due to production planning and health and safety concerns (e.g. batch cross contamination or breaking the cold chain). So for many stages, you can limit the relevant food objects to a time window as narrow as 10-15 minutes, an hour, a production shift or a day. Features calculated from previously mentioned processes such as segmentation (FIG. 11 and FIG. 12), and weight measurements can also be used in the fingerprinting process.

The system and method described above using the device that captures real-time Primal cut (meat) processing data in a meat butchery environment to provide the user with the information needed to improve the efficiency of their process, reduce waste, and save cost. Primal Cut refers to the prominent cuts of meat to be separated from the carcass of an animal during the butchering process. These are whole muscles or large sections of muscles removed from the carcass, for example sirloin, ribeye, fillet, rump, chuck. This process saves time, wastage and improves efficiency in the food industry.

What is claimed is:

1. A method, comprising:
gathering a food data using a device continuously or discreetly at least one of a user specified time or algorithmically specified time on a processing station of a food object;
performing a food processing task at the processing station for a food object using the food data generated by the device using a specific software algorithm, a computer vision and machine learning algorithm residing in a processor to produce a processed data;
analyzing the processed data using a system to distinguish between a non-food data and the food data;
generating a final data after analysis of the processed data by the system for a user; and
producing a guided process using a guidance system to produce an optimal protocol for a new food object processing task.

2. The method of claim 1, wherein the guidance system implements a cut guidance protocol for a beef primal meat to comply with user requirement.

3. The method of claim 1, wherein the specific algorithm uses an image data and a depth data of the food object gathered from the food data to provide a cut guidance protocol for performing the food processing task of trimming the food object.

4. The method of claim 1, wherein the specific algorithm uses an image data, a depth data of the food object from the food data and a machine learning algorithm is applied to identify an unidentified food object to provide a cut guidance protocol for performing the food processing task of trimming the food object.

5. The method of claim 1, wherein the specific algorithm uses an image data, a depth data of the food object to produce gathered from the food data and a production data is included to provide a cut guidance protocol for performing the food processing task of trimming the food object.

6. A method, comprising:
collecting a food object data using a sensor continuously or discreetly at least one of a user specified time or algorithmically specified time on a processing station of a food object;
embedding the food object data with a unique identifier and store in a database as an embedded data specific for the food object before transforming the food object;
filtering of the food object data gathered using a food object and non-food object to produce a filtered food object data;
performing a food processing task for a food object using the food data generated by the device using a specific software algorithm, a computer vision and machine learning algorithm residing in a processor to produce a processed data;
generating a final data after analysis of the processed data by the system for a user; and
producing a guided process from the final data to produce an optimal protocol for a new food object processing task.

7. The method of claim 6, wherein the specific algorithm uses an image data, a depth data of the food object to produce gathered from the food data and a production data, using the processor, is included to provide a cut guidance protocol for performing the food processing task of trimming the food object.

8. The method of claim 6, further comprising:
comparing an old embedded data to the newly generated embedded data to identify the food object.

9. The method of claim 8, wherein if the embedded data is similar then the embedded data specific for the food object the unique identifier are set to the same value in a database.

10. The method of claim 6, wherein the transformation include trimming, cutting, slicing, dicing, pealing, deboning, freezing, packing, compressing, moving, or any other change to the food object.

11. A system to process a food object, comprising:
a device to gather a food data continuously or discreetly at least one a user specified time or algorithmically specified time on a processing station of a food object;
a processing station to perform a food processing task automatically or manually for a food object using the food data generated by the device using a specific software algorithm, a computer vision and machine learning algorithm residing in a processor to produce a processed data;
a processor to analyze the processed data using to distinguish between a non-food data and the food data;
a guidance system to generate an optimal protocol for a guided process from the final data for a new food object processing task; and
generating a final data after analysis of the processed data by the system for a user.

12. The system of claim 11, wherein the guidance system implements a cut guidance protocol for a beef primal meat to separate a primary food object from other food objects.

13. The system of claim 11, wherein the specific algorithm uses an image data and a depth data of the food object to produce gathered from the food data to provide a cut guidance protocol for performing the food processing task of trimming the food object.

14. The system of claim 11, wherein the specific algorithm uses an image data, a depth data of the food object to produce gathered from the food data and a machine learning algorithm is applied to identify an unidentified food object to provide a cut guidance protocol for performing the food processing task of trimming the food object.

15. The system of claim 11, wherein the specific algorithm uses an image data, a depth data of the food object to produce gathered from the food data and a production data is included to provide a cut guidance protocol for performing the food processing task of trimming the food object.

16. The system of claim 11, further comprising:
the processor compares an old embedded data to the newly generated embedded data to identify the food object.

17. The system of claim 16, wherein if the embedded data is similar then the embedded data specific for the food object the unique identifier are set to the same value in a database.

18. The system of claim 11, wherein the transformation include trimming, cutting, slicing, dicing, pealing, deboning, freezing, packing, compressing, moving, or any other change to the food object.

19. The system of claim 11, wherein the device is one of a sensor, wherein the sensor is one of a camera, depth sensor, IR emitter and receiver, load cell, other hyper-spectral imaging device, and hyper-spectral probe.

20. The system of claim 15, wherein the cut guidance protocol can be used by displaying results in augmented reality form, overlay a trimming process on the food object at the processing station, and human machine interface output.
